(19) United States
(12) Patent Application Publication
(10) Pub. No.: US 2006/0096910 A1
(43) Pub. Date: May 11, 2006

(54) Hybrid fabric filtration device

(76) Inventors: Jerry M. Brownstein, Issaquah, WA (US); Kathy R. Brownstein, Issaquah, WA (US); Brent A. Hepner, Maple Valley, WA (US)

Correspondence Address: ROGERS TOWERS, P.A., 1301 RIVERPLACE BOULEVARD, SUITE 1500, JACKSONVILLE, FL, 32207, US

(21) Appl. No.: 10/985,463

(22) Filed: Nov. 10, 2004

(51) Int. Cl. B01D 39/08

(52) U.S. Cl. 210/490; 210/503; 210/504; 210/508

(57) ABSTRACT

An adsorbent hybrid filtration fabric device that comprises a first layer of a loose fiber adsorbent material in the form of a fabric or wadded mass ideally suited for adsorption or filtering of hydrocarbon contaminants comprising a plurality of relatively shorter hydrophobic and lipophilic synthetic fibers, a plurality of relatively longer hydrophobic and lipophilic synthetic fibers, and additional absorption, adsorption, reactive or ionic components, typically in a granular form, wherein the added treatment component is embedded, fused or otherwise adhered to the fabric material, wherein the embedded treatment component is disposed between two layers of fabric material, the second layer of fabric material being identical to the first layer or composed of a synthetic polymer material.

### BACKGROUND OF THE INVENTION

The present invention relates generally to the field of filters or treatment media directed to the removal of hydrocarbon contaminants or hydrocarbon contaminants combined with other contaminants from a liquid, and more particularly to the field of such devices wherein multiple filter, absorbent or adsorbent means are combined to formed a hybrid filtration device, and even more particularly to the field of such devices that comprise a fabric component. Even more particularly, the invention is generally directed to such devices that comprise a fiber sorbent fabric material comprising a wadded mass of delustered hydrophobic and lipophilic fibers.

The widespread use of petroleum products is accompanied by the almost statistical certainty that accidents involving the release of petroleum products into the environment will occur. In recognition of the deleterious effects such hydrocarbon spills can have on the environment, many governmental agencies have drafted regulations mandating that spill response equipment, including sorbent material, be readily available to contain and collect the spilled material to minimize the deleterious environmental effects of the petroleum products. In addition, it is often necessary to provide a means to filter or treat contaminated liquid that includes other contaminants in addition to hydrocarbons.

The prior art includes many different types of sorbent products. Sorbents work either by absorption, adsorption, or both. Absorption is a process in which a material is taken in through pores or interstices of another material, while adsorption is a process in which a material is accumulated on the surface of a solid or liquid. In general, sorbents that function via both absorption and adsorption tend to be more effective in enabling a petroleum or other hydrocarbon contaminant to be collected and removed.

The prior art recognizes that an effective sorbent material should have a high affinity for sorbing the target material to be collected and removed, and that the sorbent should preferably sorb a relatively large amount of the target material per unit weight of the sorbent. Effective sorbents tend to have a relatively great surface area, so as to encourage contact of the sorbent with the target material. With respect to sorbents employed to recover hydrocarbons from the surface of a body of water, a low specific gravity ensures that the sorbent will float on the water surface, both before and after hydrocarbons have been sorbed.

In our U.S. Pat. No. 6,632,501, issued On Oct. 14, 2003, the disclosure of which is expressly incorporated herein, a loose fiber adsorbent material, comprising for example a fabric or textile blanket, ideally suited for adsorption or filtering of hydrocarbon contaminants is disclosed. This material comprises a plurality of relatively shorter hydrophobic and lipophilic synthetic fibers, the relatively shorter hydrophobic and lipophilic synthetic fibers having rough, delustered surfaces, wherein the plurality of relatively shorter hydrophobic and lipophilic synthetic fibers comprises a mixture of polyester fibers and nylon fibers, and a plurality of relatively longer hydrophobic and lipophilic synthetic fibers, the relatively longer hydrophobic and lipophilic synthetic fibers having rough, delustered surfaces, the relatively longer hydrophobic and lipophilic synthetic fibers and the rough delustered surfaces binding the plurality of relatively shorter hydrophobic and lipophilic synthetic fibers and the plurality of relatively longer hydrophobic and lipophilic fibers into a wadded mass, the wadded mass including a plurality of interstitial spaces and having a density that is substantially less than that of water, so that the wadded mass is adapted to float on a surface of a body of water, and wherein the plurality of relatively longer hydrophobic and lipophilic synthetic fibers comprises a mixture of polyester fibers and nylon fibers. This product is currently marketed under the brand name X-TEX by the Xextex Corp.

It is an object of this invention to provide an improved adsorbent filtering device that incorporates the material of U.S. Pat. No. 6,632,501, by providing a device that includes additional absorption, adsorption, reactive or ionic components, typically in a granular form, such that the overall effectiveness of the device relative to capture, filtering or treatment of hydrocarbon and other contaminants is greatly enhanced. It is a further object to provide such a hybrid adsorbent filtering device wherein the added treatment component is embedded, fused or otherwise adhered to the X-TEX fabric material and/or to other fabric material forming a composite member, wherein the embedded treatment component does not interfere with liquid flow through the device and wherein the method of adherence for the embedded treatment component does not interfere with the efficiency of the embedded treatment component. It is a further object to provide such a device wherein the embedded treatment component may comprise any inorganic elements, compounds or mixtures whether manufactured or in a natural state, any mined ores including clays, metal bearing or organic humates, any organic compounds whether synthesized or naturally occurring, and any organometallic compounds or organic immobilized compounds on an organic or inorganic substrate, any of which possess desirable adsorbent, adsorbent, filtering or treatment characteristics or properties and which do not interfere with the adsorption and filtering properties of the X-TEX material.

### SUMMARY OF THE INVENTION

The invention is an improved adsorbent hybrid filtration fabric that comprises at least one layer of a loose fiber adsorbent material in the form of a fabric or wadded mass ideally suited for adsorption or filtering of hydrocarbon contaminants comprising a plurality of relatively shorter hydrophobic and lipophilic synthetic fibers, the relatively shorter hydrophobic and lipophilic synthetic fibers having rough, delustered surfaces, wherein the plurality of relatively shorter hydrophobic and lipophilic synthetic fibers comprises a mixture of polyester fibers and nylon fibers, and a plurality of relatively longer hydrophobic and lipophilic synthetic fibers, the relatively longer hydrophobic and lipophilic synthetic fibers having rough, delustered surfaces, the relatively longer hydrophobic and lipophilic synthetic fibers and the rough delustered surfaces binding the plurality of relatively shorter hydrophobic and lipophilic synthetic fibers and the plurality of relatively longer hydrophobic and lipophilic fibers into a wadded mass, the wadded mass including a plurality of interstitial spaces and having a density that is substantially less than that of water, and wherein the plurality of relatively longer hydrophobic and lipophilic synthetic fibers comprises a mixture of polyester fibers and nylon fibers, such material to be referred to herein as X-TEX, and additional absorption, adsorption, reactive or ionic components, typically in a granular form, wherein the added treatment component is embedded, fused or otherwise adhered to the X-TEX fabric material and/or to other fabric material forming a composite member, wherein the embedded treatment component does not interfere with liquid flow through the device and wherein the method of adherence for the embedded treatment component does not interfere with the efficiency of the embedded treatment component.

The embedded treatment component may comprise any inorganic elements, compounds or mixtures whether manufactured or in a natural state, any mined ores including clays, metal bearing or organic humates, any organic compounds whether synthesized or naturally occurring, and any organometallic compounds or organic immobilized compounds on an organic or inorganic substrate, any of which possess desirable absorbent, adsorbent, filtering or treatment characteristics or properties and which do not interfere with the adsorption and filtering properties of the X-TEX material.

The embedded treatment component is preferably disposed between two layers of X-TEX material or between a layer of X-TEX material and a layer composed of a synthetic polymer material, preferably polyester. In alternative embodiments, multiple layers of X-TEX material or synthetic material and multiple layers of embedded treatment components may be provided to create a multi-layer device.

### BRIEF DESCRIPTION OF THE DRAWINGS

FIG. 1 is a partially exposed view of the invention, shown as having a first fabric layer, a second fabric layer joined to the first fabric layer, and embedded treatment component in granular form disposed between the two fabric layers.

FIG. 2 is a side view of a multi-layer embodiment of the invention.

### DETAILED DESCRIPTION OF THE INVENTION

With reference to the drawings, the invention will now be described in detail with regard for the best mode and the preferred embodiment. In a broad sense, the invention is an improved adsorbent hybrid filtration fabric device that comprises a first layer of a loose fiber adsorbent material in the form of a fabric or wadded mass ideally suited for adsorption or filtering of hydrocarbon contaminants comprising a plurality of relatively shorter hydrophobic and lipophilic synthetic fibers, a plurality of relatively longer hydrophobic and lipophilic synthetic fibers, and additional absorption, adsorption, reactive or ionic components, typically in a granular form, wherein the added treatment component is embedded, fused or otherwise adhered to the fabric material, wherein the embedded treatment component is disposed between two layers of fabric material, the second layer of fabric material being identical to the first layer or composed of a synthetic polymer material. As used herein, the term fabric shall be taken to include both woven and non-woven materials.

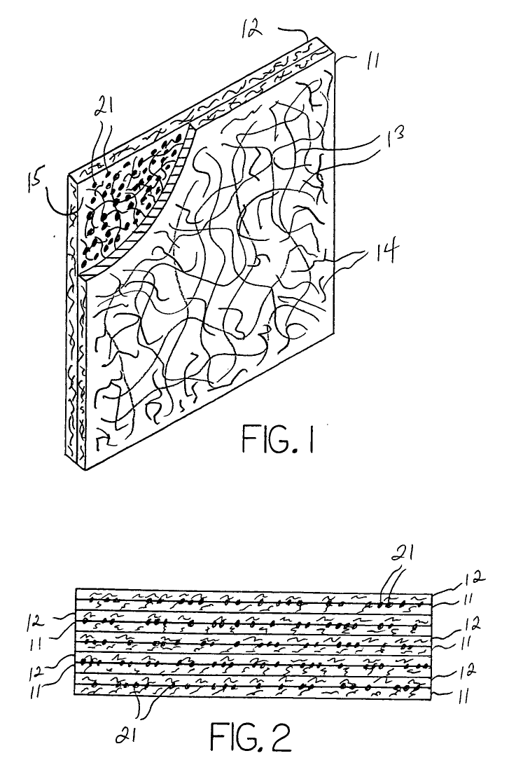

As shown in FIG. 1, the invention is an adsorbent hybrid filtration fabric device comprising a first fabric layer 11 and a second fabric layer 12, the two layers 11 and 12 encasing an embedded component 21 therebetween. The two layers 11 and 12 are joined to each other in any suitable manner, such as through stitching, adhesive bonding, melt bonding, etc. The two layers 11 and 1 may be joined about the perimeter to create an internal pocket or may be joined generally coextensively across their interior faces 15 to create an integral device. In an alternative embodiment illustrated in FIG. 2, the adsorbent hybrid filtration fabric device may comprise multiple sets of first and second fabric layers 1 and 12, suitably joined to define an integral device.

The exact proportions of the individual fibers 13 and 14 are not critical, though a majority of the fibers need to be relatively short, while only a minority of the fibers should be relatively long. The relatively short fibers 14 provide a great deal of surface area, while the relatively long fibers 13 help bind the relatively short fibers 14 and relatively long fibers 13 together into a wadded mass. In one preferred embodiment, the relatively short fibers 14 are on the order of from about 5 mm to about 15 mm in length, while the relatively long fibers 13 are on the order of from about 85 mm to about 100 mm in length. Such an embodiment also includes a plurality a fibers of intermediate length, ranging from about 15 mm to about 85 mm in length.

A mixture of different fiber types is acceptable. The majority of the fibers must be hydrophobic and lipophilic (i.e., capable of adsorbing hydrocarbon products). Synthetic fibers such as polyester, nylon, acrylic, and triacetate can be beneficially employed as the majority of fibers. In a preferred embodiment, approximately 70% of the fibers are polyester, approximately 20% of the fibers are nylon, less than about 2% of the fibers are acrylic, and less than about 1% of the fibers are triacetate. It is anticipated that these relative percentages can vary considerably and still provide a useful sorbent, as each of the fibers individually meet the criteria of being hydrophobic and lipophilic (capable of sorbing a hydrocarbon).

In a preferred embodiment of the present invention, a majority of the fibers 13 and 14 are relatively thick, while a minority of the fibers 13 and 14 are relatively thin. Again, the exact proportions of the individual fibers are not critical. In the preferred embodiment of the invention noted above, a majority of the fibers are relatively thick, while a minority of the fibers are relatively thin. The relatively thick fibers are on the order of about 45 microns in diameter, while the relatively thin fibers are on the order of about 15 microns in diameter. Relative diameters within the wadded mass can be varied by varying the mixtures of fibers employed.

It has been determined that delustering enhances the sorbency of synthetic fibers, which inherently have a sheen due to their smooth outer surface. The delustering effect has been empirically determined, and it is believed that at least two mechanisms are responsible for the increase in sorbency for delustered fibers. First, delustering significantly roughens the surface of individual fibers, significantly increasing the surface area of each individual fiber, and thus enabling a greater amount of adsorption per fiber. Secondly, it should be noted that rough surfaces of the individual fibers, in combination with the mix of short and long fiber lengths, enable a surprisingly cohesive wad of fiber sorbent to be achieved. The rough surfaces provide fiber-to-fiber traction, enabling adjacent fibers to better adhere to one another. The mix of a minor portion of relatively long fibers 13 to a majority of relatively short fibers 14 ensures that sufficient relatively long fibers 13 are present to help bind the wadded mass together without the need for binding agents normally employed to bind amorphous masses of fiber together. This wadded mass configuration ensures that a significant amount of interstitial volume is available for absorption. Thus delustering is believed to enhance sorption by providing more sites for both adsorption and absorption to occur. While the wadded mass of the present invention, with its majority of relatively short fibers 14 providing significant surface area, begins to sorb hydrocarbon products immediately upon contact, it is anticipated that it will be preferred to leave the wadded mass in contact with the hydrocarbon product to be sorbed for a reasonable length of time (for example, 10 minutes or more). While the process of adsorbing hydrocarbon products onto surfaces of the relatively short fibers 14, and the surfaces of relatively long fibers 13 occurs rapidly, the process of absorption is expected to require more time. Absorption will occur in interstitial regions within the wadded mass. Delustering using titanium dioxide is a preferred technique, since it adds a significant amount of surface area to each individual fiber surface, as well as helping the fibers maintain a wadded mass configuration in which a plurality of interstitial volumes are available for absorption.

It should further be noted that the hydrophobic and lipophilic fibers used in the present invention are light weight, and that they sorb up to 20 times their own weight. The mass of sorbent required to sorb a given volume of hydrocarbon is significantly less than the mass of some other types of sorbents, which reduces the final mass and volume of the used sorbent that must be disposed of, making the disposal cost of the sorbent of the present invention more economical.

As discussed in more detail below, a sorbent wadded mass in accord with the present invention is useable in a filter frame, in which the sorbent retains its wadded mass configuration. The delustered hydrophobic and lipophilic fibers of the present invention produce a filter media effective in removing oils, greases, suspended particulates, vegetable oils, and animal oils. When employed as a filter media, the delustered hydrophobic and lipophilic fibers do not significantly impede water flow. Various different filter configurations are possible. While it is anticipated that a wadded mass will provide superior filtering abilities, due to the significant interstitial volume in a wadded mass, it should be noted that some filter applications may preferably employ a mat or pad configuration, as opposed to a wadded mass configuration. Even when the delustered hydrophobic and lipophilic fibers of the present invention are configured in a mat or pad, such that the additional sorbency of the wadded mass configuration is not achieved, such delustered hydrophobic and lipophilic fibers are very useful in removing oils and other hydrocarbons from a mass of water flowing through the fibers. Filter units using such delustered hydrophobic and lipophilic fibers can be designed to have a size and shape compatible with most filtering applications.

Additional absorption, adsorption, reactive or ionic components 21, typically in a granular form, are disposed between the first and second fabric layers 11 and 12, wherein the added treatment component 21 is embedded, fused or otherwise adhered to at least one of the interior faces 15 of the first layer 11, second layer 12 or both, wherein the embedded treatment component 21 does not interfere with liquid flow through the device and wherein the method of adherence for the embedded treatment component 21 does not interfere with the efficiency of the embedded treatment component 21. By adhering or fixing the treatment component 21 to at least one of the fabric layers 11 and 12, the treatment component 21 does not aggregate to create channel effects detrimental to the filtration effectiveness. Furthermore, with the treatment component 21 adhered or embedded, a particular filter can be cut to shape or size as desired without causing loss of treatment component 21.

The embedded treatment component 21 may comprise any inorganic elements, compounds or mixtures whether manufactured or in a natural state, any mined ores including clays, metal bearing or organic humates, any organic compounds whether synthesized or naturally occurring, and any organometallic compounds or organic immobilized compounds on an organic or inorganic substrate, any of which possess desirable adsorbent, adsorbent, filtering or treatment characteristics or properties and which do not interfere with the adsorption and filtering properties of the fabric layers 11 and 12.

A suitable embedded treatment component 21 that has been found experimentally to significantly enhance the filtration effectiveness of X-TEX type fabric filtration devices is activated carbon. This synergistic meld augments the capabilities of both products allowing each to perform better than they could independently and providing a rugged textile that can be shaped, cut and contoured to fit any environmental filtration application. The effectiveness of activated carbon in removing both polar and non-polar organics and some inorganic metals is well established. The adsorbent properties are attributed to its large surface area, ionic interactions, hydrogen bonding and surface reactivity. These properties are greatly diminished when the carbon is fouled with oils, sediment or other organic debris. The first layer 11, acting as a pre-filter layer for activated carbon, protects it from the fouling effects of oils and sediments. The carbon bed acts as a diffusing bed, preventing channeling effects as water filters through the second layer of fabric 12.

Environmental applications include storm drain inserts with enhanced ability to remove emulsions as well as polar organics and some metals. Filtration cartridges with a rolled layering of the filtration fabric device multiply the overall effectiveness of environmental water filtration applications and final polishing.

The following test was designed and conducted to compare the oil removal efficiencies of polypropylene and the invention comprising activated carbon, designated in this test as X-TEX-AC. Polypropylene is by far the most used media for oil removal from the environment but not the most efficient. X-TEX-AC incorporates a bed of activated carbon embedded between two layers of X-TEX oil adsorbent textile.

A 9 by 12 inch plastic drain frame was assembled to hold the test filter media. Each test material was cut into a 14 by 18 inch rectangle that allowed for a 4-inch deep pocket to be formed for the introduction of the effluent oil stream. The insert material was clamped between the plastic frame and PVC pipe was used to deliver a constant water flow of 2 liters per minute. The end section of the pipe was perforated to allow even distribution of water over the entire length of the test area pocket.

A mixture of 50 percent used motor oil and 50 percent diesel was injected into the PVC delivery pipe using a metering pump. The oil was metered into the influent stream at one gram per minute, and the flow rate was held constant at 2 liters per minute. The influent had a measured concentration 518 mg/l as the raw unfiltered basis for calculation. Although this concentration is much higher than actual environmental field conditions, the amount of oil effluent was sufficient to measure a break-through point of each material.

Each material tested was exposed to a total of a 15-minute flow of oil/water effluent. Samples were collected at 1,2,4,6,8 and 15 minute intervals of filtering. A total of 15.54 grams of oil was discharged with 30 liters of water for each test. The oil/water effluent passed through both materials for all tests without collecting or pooling. Samples were analyzed using EPA 1664 method for total oil and grease.

While both medias preformed similarly for the first 2 minutes, X-TEX-AC dramatically out performed polypropylene media for the remainder of the test, maintaining a greater than 95 percent removal efficiency for the entire test while the polypropylene dropped to under 30 percent.

TABLE 1
Diesel/Motor Oil Removal from Water -
Polypropylene Textile vs. X-TEX-AC100

| | Oil Break- | Oil Break- | Percent oil | Percent oil |
|---|---|---|---|---|
| | through | through | Removed | Removed |
| Time | Polypropylene | X-TEX-AC | Polypropylene | X-TEX-AC |
| (min) | (ppm) | (ppm) | (%) | (%) |
| 1 | 15 | 2.4 | 97.1 | 99.6 |
| 2 | 59 | 2.2 | 88.6 | 99.6 |
| 4 | 119 | 1.9 | 77 | 99.6 |
| 6 | 193 | 3.1 | 62.7 | 99.4 |
| 8 | 252 | 4.1 | 51.4 | 99.2 |
| 15 | 367 | 25 | 29.2 | 95.2 |

The same test as above was performed using the same influent flow of 518 mg/l oil/water, however the test duration was six minutes instead of 15, giving a total load of 6.2 grams of oil. The total filtrate or effluent was collected past the filtration insert and analyzed by EPA Method 1664 for total oil and grease on a weight basis. The polypropylene insert removed 4148 mg of oil, but allowed to break-thru 2062 mg of oil resulting in a 66.9% removal rate. The X-TEX-AC100 insert removed 6199.9 mg of oil and allowed break-thru of only 18 mg of oil, resulting in a 99.99% removal rate.

Another suitable embedded treatment component 21 that has been found experimentally to significantly enhance the filtration effectiveness of X-TEX type fabric filtration devices is zeolite. The hybrid filtration fabric, referred to as X-TEX-Z-200 is designed to remove oils through adsorption and certain dissolved metals and nutrients by cation-exchange. X-TEX-Z-200 incorporates zeolite embedded between two layers of X-TEX fabric. One of the main problems of using ion exchange materials for removing metals and nutrients is the premature failure caused by oil contamination of the material. By embedding zeolite between X-TEX the problem of oil contamination is remedied by trapping the oil before the influent makes contact with the zeolite. There are many types of zeolites (clinoptilolite, chabazite, phillipsite, mordenite, etc.) with different chemical and physical characteristics. Crystal structure and chemical composition account for much of the differences. Particle size and density, cation selectivity, and pore size are only some of the characteristics that can differ depending on the zeolite in question. Variations not only occur between different types of zeolites but also in the properties of zeolites of the same group.

Still another suitable embedded treatment component 21 that has been found experimentally to significantly enhance the filtration effectiveness of X-TEX type fabric filtration devices is an oil encapsulating polymer blend marketed under the brand CIAGENT. This hybrid creates a filtration fabric, referred to herein as X-TEX-CIAGENT, that adsorbs oil instantly, encapsulates breakthrough oils, seals off oil saturated areas of the fabric and forces the oil to unsaturated areas of the fabric. This imparts to the fabric tremendous oil loading capacity that prevents oil breakthrough until the entire fabric is utilized.

X-TEX-CIAGENT in laboratory tests has shown greater efficiency in removing small suspended oil droplets found in mechanical emulsions making it a stellar performer for oil sheen removal for final polishing of effluent waters. This new fabric is ideal for storm water filtration as it removes oil on contact, encapsulates, and prevents oil breakthrough. The textile utilizes the whole fabric for adsorption and encapsulation as the effluent water is forced to unsaturated areas not sealed of by the polymerization process of oil encapsulation. X-TEX-CIAGENT has applications for SPCC spill containment, floating booms, boom sleeves and adsorbent pads. A comparison of X-TEX-CIAGENT fabric to conventional polypropylene filtration fabric is given in the following table.

TABLE 2
Tabulated results comparing oil removal efficiency
of X-TEX-CIAGENT media embedded to Polypropylene
catch basin insert material

| X-TEX-CIAGENT (single layer) | | | | | Polypropylene (2 layers) | | | | |
|---|---|---|---|---|---|---|---|---|---|
| Serial additions | | | | | Serial additions | | | | |
| 1 liter 4,500 ppm motor oil/diesel | | | | | 1 liter 4,500 ppm motor oil/diesel | | | | |
| | | Results | | | | | Results | | |
| | | after | | % | | | after | | % |
| | | filtration | | removal | | | filtration | | removal |
| 1 | liter | 1.5 | ppm | 99.97 | 1 | liter | 37.3 | ppm | 99.17 |
| 2 | liter | 3.5 | ppm | 99.92 | 2 | liter | 54.3 | ppm | 98.79 |
| 3 | liter | 3.4 | ppm | 99.92 | 3 | liter | 257 | ppm | 94.31 |
| 4 | liter | 3.3 | ppm | 99.93 | 4 | liter | 512 | ppm | 88.63 |
| 5 | liter | 4.0 | ppm | 99.91 | 5 | liter | 1188 | ppm | 73.59 |
| 6 | liter | 4.8 | ppm | 99.89 | 6 | liter | 1332 | ppm | 70.38 |
| 7 | liter | 4.7 | ppm | 99.91 | 7 | liter | 1813 | ppm | 59.71 |
| 8 | liter | 7.0 | ppm | 99.84 | 8 | liter | 2410 | ppm | 46.44 |
| 9 | liter | 27.8 | ppm | 99.38 | 9 | liter | 3021 | ppm | 32.85 |
| 10 | liter | 94.3 | ppm | 97.91 | 10 | liter | 3102 | ppm | 31.06 |

| | | | |
|---|---|---|---|
| Total | 154.3 | Total | 13,727 |
| ppm oil | | ppm oil | |
| released | | released | |

While the present invention has been described in connection with preferred forms for practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

We claim:

1. A filtration device comprising:
a first fabric layer suitable for adsorbing a liquid hydrocarbon, said first fabric layer comprising:
a plurality of relatively shorter hydrophobic and lipophilic synthetic fibers, said relatively shorter hydrophobic and lipophilic synthetic fibers having rough, delustered surfaces, wherein said plurality of relatively shorter hydrophobic and lipophilic synthetic fibers comprises a mixture of polyester fibers and nylon fibers;
a plurality of relatively longer hydrophobic and lipophilic synthetic fibers, said relatively longer hydrophobic and lipophilic synthetic fibers having rough, delustered surfaces, said relatively longer hydrophobic and lipophilic synthetic fibers and said rough delustered surfaces binding said plurality of relatively shorter hydrophobic and lipophilic synthetic fibers and said plurality of relatively longer hydrophobic and lipophilic fibers into a wadded mass, said wadded mass including a plurality of interstitial spaces, wherein said plurality of relatively longer hydrophobic and lipophilic synthetic fibers comprises a mixture of polyester fibers and nylon fibers; and
a second fabric layer joined to said first fabric layer; and
a granular component embedded between said first and second layers, said granular component having desirable adsorbent, absorbent, filtering or treatment characteristics, said granular component being a treatment component chosen from the group of treatment components consisting of:
inorganic elements, compounds and mixtures;
mined ores, including clays, metal bearing and organic humates;
organic compounds; and
organometallic compounds and organic immobilized compounds on an organic or inorganic substrate.

2. The device of claim 1, wherein said granular component is adhered to at least one of said first and second layers.

3. The device of claim 1, wherein said second layer is composed of material identical to said first layer.

4. The device of claim 1, wherein said second layer is composed of synthetic fibers different from those of said first layer.

5. The device of claim 4, wherein said second layer is composed of polyester.

6. The device of claim 1, wherein said granular component comprises activated carbon.

7. The device of claim 1, wherein said granular component comprises zeolite.

8. A filtration device suitable for adsorbing a liquid hydrocarbon product, said filtration device comprising at least two fabric layers, at least one of said fabric layers comprising:
a plurality of relatively shorter hydrophobic and lipophilic synthetic fibers, a majority of said plurality of relatively shorter hydrophobic and lipophilic synthetic fibers having lengths ranging from about 10 mm to about 20 mm, wherein said plurality of relatively shorter hydrophobic and lipophilic synthetic fibers comprises a mixture of polyester fibers and nylon fibers; and
a plurality of relatively longer hydrophobic and lipophilic synthetic fibers, a majority of said plurality of relatively longer hydrophobic and lipophilic synthetic fibers having lengths ranging from about 70 mm to about 90 mm, said relatively longer hydrophobic and lipophilic synthetic fibers binding said plurality of relatively shorter hydrophobic and lipophilic synthetic fibers and said plurality of relatively longer hydrophobic and lipophilic fibers, wherein said plurality of relatively longer hydrophobic and lipophilic synthetic fibers comprises a mixture of polyester fibers and nylon fibers; and
a granular component embedded between said two fabric layers, said granular component having desirable adsorbent, absorbent, filtering or treatment characteristics, said granular component being a treatment component chosen from the group of treatment components consisting of:
inorganic elements, compounds and mixtures;
mined ores, including clays, metal bearing and organic humates;
organic compounds; and
organometallic compounds and organic immobilized compounds on an organic or inorganic substrate.

9. The device of claim 8, wherein said granular component is adhered to at least one of said fabric layers.

10. The device of claim 8, wherein said two layers are composed of identical material.

11. The device of claim 1, wherein one said fabric layer is composed of synthetic fibers different from said other fabric layer.

12. The device of claim 11, wherein said synthetic fibers are polyester.

13. The device of claim 8, wherein said granular component comprises activated carbon.

14. The device of claim 8, wherein said granular component comprises zeolite.

15. The device of claim 8, wherein each mixture of polyester fibers and nylon fibers comprises substantially more polyester than nylon.

16. The device of claim 15, wherein a ratio of polyester fibers to nylon fibers ranges from about 2:1 to about 4:1.

17. The device of claim 8, wherein said plurality of relatively shorter hydrophobic and lipophilic fibers and said plurality of relatively longer hydrophobic and lipophilic fibers have rough, delustered surfaces, said rough, delustered surfaces providing fiber-to-fiber traction that enhances a cohesiveness of said wadded mass, said rough, delustered surfaces further enhancing a volume of interstitial space within said wadded mass, said interstitial space enabling said sorbent mass to also absorb said liquid hydrocarbon, the absorption occurring within said interstitial spaces.

18. The device of claim 8, wherein said relatively shorter hydrophobic and lipophilic fibers and said relatively longer hydrophobic and lipophilic fibers comprise fibers ranging in length from about 5 mm to about 100 mm.

19. The device of claim 8, wherein said wadded mass is capable of adsorbing an amount of liquid hydrocarbon up to about 25 times a weight of said wadded mass.

20. A filtration device comprising at least two fabric layers, at least one of said fabric layers comprising a delustered fiber sorbent suitable for adsorbing an organic liquid, said delustered fiber sorbent comprising:
a plurality of relatively shorter delustered hydrophobic and lipophilic synthetic fibers, wherein said plurality of relatively shorter delustered hydrophobic and lipophilic synthetic fibers comprises a mixture of polyester fibers and nylon fibers, and
a plurality of relatively longer delustered hydrophobic and lipophilic synthetic fibers, wherein said plurality of relatively longer delustered hydrophobic and lipophilic synthetic fibers comprises a mixture of polyester fibers and nylon fibers; and
a granular component embedded between said two fabric layers, said granular component having desirable adsorbent, absorbent, filtering or treatment characteristics, said granular component being a treatment component chosen from the group of treatment components consisting of:
inorganic elements, compounds and mixtures;
mined ores, including clays, metal bearing and organic humates;
organic compounds; and
organometallic compounds and organic immobilized compounds on an organic or inorganic substrate.

21. The device of claim 20, wherein:
said plurality of relatively shorter hydrophobic and lipophilic synthetic fibers includes a majority of relatively shorter hydrophobic and lipophilic synthetic fibers having lengths ranging from about 10 mm to about 20 mm; and
said plurality of relatively longer hydrophobic and lipophilic synthetic fibers includes a majority of relatively longer hydrophobic and lipophilic synthetic fibers having lengths ranging from about 70 mm to about 90 mm, said relatively longer hydrophobic and lipophilic synthetic fibers binding said plurality of relatively shorter hydrophobic and lipophilic synthetic fibers and said plurality of relatively longer hydrophobic and lipophilic synthetic fibers into a wadded mass.

22. The device of claim 20, wherein said plurality of delustered hydrophobic and lipophilic synthetic fibers comprises:
a majority of relatively shorter hydrophobic and lipophilic synthetic fibers; and
a minority of relatively longer hydrophobic and lipophilic synthetic fibers.

23. The device of claim 20, further comprising a plurality of hydrophilic fibers, such that said delustered fiber sorbent comprises substantially more delustered hydrophobic and lipophilic synthetic fibers than hydrophilic fibers.

24. The device of claim 20, wherein said granular component comprises activated carbon.

25. The device of claim 20, wherein said granular component comprises zeolite.

26. A delustered fiber filter suitable for removing an organic liquid from a mass of water, said delustered fiber filter comprising at least two fabric layers, at least on of said layers comprising a plurality of delustered hydrophobic and lipophilic synthetic fibers, wherein said plurality of delustered hydrophobic and lipophilic synthetic fibers comprises a mixture of polyester fibers and nylon fibers and a mixture of relatively shorter fibers and relatively longer fibers; and
a granular component embedded between said two layers, said granular component having desirable adsorbent, absorbent, filtering or treatment characteristics, said granular component being a treatment component chosen from the group of treatment components consisting of:
inorganic elements, compounds and mixtures;
mined ores, including clays, metal bearing and organic humates;
organic compounds; and
organometallic compounds and organic immobilized compounds on an organic or inorganic substrate.

27. The delustered fiber filter of claim 26, wherein said plurality of delustered hydrophobic and lipophilic synthetic fibers further comprises a majority of relatively shorter hydrophobic and lipophilic synthetic fibers and a minority of relatively longer hydrophobic and lipophilic synthetic fibers.

28. The delustered fiber filter of claim 26, further comprising a plurality of hydrophilic fibers, such that said delustered fiber filter comprises substantially more delustered hydrophobic and lipophilic synthetic fibers than hydrophilic fibers.

29. The delustered fiber filter of claim 26, wherein said delustered fiber filter does not substantially impede a flow of water through said delustered fiber filter.

30. The device of claim 26, wherein said granular component comprises activated carbon.

31. The device of claim 26, wherein said granular component comprises zeolite.
